(19) United States
(12) Patent Application Publication
(10) Pub. No.: US 2025/0004759 A1
(43) Pub. Date: Jan. 2, 2025

(54) TUTORIAL OPTIMIZATION AND SYNCHRONIZATION

(71) Applicant: INTERNATIONAL BUSINESS MACHINES CORPORATION, ARMONK, NY (US)

(72) Inventors: Su Liu, Austin, TX (US); Hamid Majdabadi, Ottawa (CA); Nageswara Sastry Renduchintala, Bengaluru (IN); Janani Janakiraman, Austin, TX (US)

(21) Appl. No.: 18/343,708

(22) Filed: Jun. 28, 2023

(51) Int. Cl. G06F 8/73

(52) U.S. Cl. CPC G06F 8/73; G09B 5/065

(57) ABSTRACT

A method and system for optimization and synchronization of a tutorial include a monitor monitoring developing activities relative to the tutorial. A collector then collects information relative to the developing activities. Once information is collected, a detector then detects changed information within the developing activity information. An identifier then identifies differences (updated features) between the information and the changed information. A descriptor then describes each of the differences. A mapper then maps descriptions of the differences to updated features. A generator then generates updated tutorial sections each including descriptions of the differences and the features. Once updated tutorial sections are generated, a verifier then verifies the updated tutorial sections. A synchronizer then updates a tutorial document with the mapped descriptions of the differences and the updated features. A renderer then renders an updated tutorial document to present differentiated aspects of the tutorial and the updated tutorial.

### BACKGROUND

### Technical Field

The present disclosure generally relates to methods and systems for tutorial optimization and synchronization, and more particularly, to methods and systems for tutorial optimization and synchronization enabled with real-time code change analysis.

### Description of the Related Art

Robotic process automation (RPA) is a fast growing sector of software technology that assists users to build and integrate RPA into current processes for improving features and user experiences. Within a project, code changes create unit test cases to validate the changed code. When code is changed, project stakeholders should be properly updated on the changes in order to be able to carry out their function relative to the project. For example, code reviewers want to understand what got changed and why the changes were made, testers want to know how to test the changed code from a tester point of view, and customers want to know how to use the changed code (or added feature in relation to the changed code).

### SUMMARY

According to an embodiment of the present disclosure, a method for optimizing and synchronizing a tutorial includes a TOS (Tutorial Optimization and Synchronization) identifier including a descriptor, a mapper, a generator, and a renderer. A TOS Verifier including a synchronizer and a TOS monitor including a collector and a detector are utilized to carry out the method. The method includes monitoring, by the TOS monitor, developing activities in development environments and tools relative to the tutorial. The collector then collects information relative to the developing activities. The detector then detects changed information within the information relative to the developing activities. Once the detector detects changed information, the TOS identifier identifies one or more specific differences between the information and the changed information, where each of the one or more specific differences are configured to be addressed as an updated feature in a tutorial document. The descriptor then describes each of the one or more specific differences.

Once the descriptor describes each of the one or more specific differences, the mapper then maps descriptions of each of the one or more specific differences to each of the updated features. The generator then generates one or more updated tutorial sections each including a respective one of the descriptions of the one or more specific differences and a respective one of the one or more updated features. The TOS verifier then verifies the one or more updated tutorial sections. The synchronizer then updates the tutorial document with each of the mapped descriptions of the one or more specific differences and each of the one or more updated features. Once the synchronizer updates the tutorial document, the renderer then renders an updated tutorial document to present differentiated aspects of portions of the tutorial and the updated tutorial.

According to an embodiment of the present disclosure, a computer program product for optimizing and synchronizing a tutorial is provided. The computer program product includes a computer readable storage medium embodying program instructions executable by a processor to cause the processor to perform a plurality of steps. A TOS monitor monitors developing activities in development environments and tools relative to the tutorial. A collector then collects information relative to the developing activities. A detector then detects changed information within the information relative to the developing activities. Once the detector detects changed information, a TOS identifier identifies one or more specific differences between the information and the changed information, where each of the one or more specific differences are configured to be addressed as an updated feature in a tutorial document. A descriptor then describes each of the one or more specific differences.

Once the descriptor describes each of the one or more specific differences, a mapper then maps descriptions of each of the one or more specific differences to each of the updated features. A generator then generates one or more updated tutorial sections each including a respective one of the descriptions of the one or more specific differences and a respective one of the one or more updated features. A TOS verifier then verifies the one or more updated tutorial sections. A synchronizer then updates the tutorial document with each of the mapped descriptions of the one or more specific differences and each of the one or more updated features. Once the synchronizer updates the tutorial document, a renderer then renders an updated tutorial document to present differentiated aspects of portions of the tutorial and the updated tutorial.

According to an embodiment of the present disclosure, a computing system is provided. There is a processor, a network module coupled to the processor to enable communication over a network, a non-transitory computer-readable storage device coupled to the processor, a tutorial optimization and synchronization (TOS) manager module coupled to the network module, and a graphical user interface coupled to the processor. A TOS identifier is coupled to the processor, where the TOS identifier includes a descriptor, a mapper, a generator, and a renderer. A TOS verifier is coupled to the processor, where the TOS verifier includes a synchronizer. A TOS monitor is coupled to the processor, where the TOS monitor includes a collector and a detector. Program instructions are stored on the non-transitory computer-readable storage device for execution by the processor via the memory.

According to an embodiment, a computing system, in conjunction with the program instructions, is configured to perform a tutorial optimization and synchronization method. The TOS monitor monitors developing activities in development environments and tools relative to the tutorial. The collector then collects information relative to the developing activities. The detector then detects changed information within the information relative to the developing activities. Once the detector detects changed information, the TOS identifier identifies one or more specific differences between the information and the changed information, where each of the one or more specific differences are configured to be addressed as an updated feature in a tutorial document. The descriptor then describes each of the one or more specific differences.

Once the descriptor describes each of the one or more specific differences, the mapper then maps descriptions of each of the one or more specific differences to each of the updated features. The generator then generates one or more updated tutorial sections each including a respective one of the descriptions of the one or more specific differences and a respective one of the one or more updated features. The TOS verifier then verifies the one or more updated tutorial sections. The synchronizer then updates the tutorial document with each of the mapped descriptions of the one or more specific differences and each of the one or more updated features. Once the synchronizer updates the tutorial document, the renderer then renders an updated tutorial document to present differentiated aspects of portions of the tutorial and the updated tutorial.

The techniques described herein may be implemented in a number of ways. Example implementations are provided below with reference to the following figures.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 is a functional block diagram illustration of a computing environment that can communicate with various networked components, consistent with an illustrative embodiment.

FIG. 2 is a conceptual block diagram showing a conventional bot and its associated functions.

FIG. 3 presents a computing system for optimizing and synchronizing a tutorial, consistent with an illustrative embodiment.

FIG. 4 is a flowchart showing exemplary processes of optimizing and synchronizing a tutorial performed in the computing system shown in FIG. 3, consistent with an illustrative embodiment.

FIG. 5 is a flowchart showing an additional exemplary process of optimizing and synchronizing a tutorial performed in the computing system shown in FIG. 3, consistent with an illustrative embodiment.

FIG. 6 is a chart showing an exemplary data update of an optimization and synchronization of a tutorial, consistent with an illustrative embodiment.

FIG. 7 is a diagram of exemplary developing activities within an integrated development environment (IDE), consistent with an illustrative embodiment.

FIG. 8 is a diagram of additional exemplary developing activities within an integrated development environment (IDE), consistent with an illustrative embodiment.

FIG. 9 is a flowchart for an example integration workflow of a tutorial optimization and synchronization bot (TOSB), consistent with an illustrative embodiment.

FIG. 10 is a flowchart for a method for optimizing and synchronizing a tutorial, consistent with an illustrative embodiment.

FIG. 11 is a flowchart for a method for optimizing and synchronizing a tutorial, consistent with an illustrative embodiment.

### DETAILED DESCRIPTION

### Overview

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring aspects of the present teachings.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

In relation to tutorials, education materials providing “what's new” and “how to education” should be created, updated, and synchronized for the stakeholders. Typically, creating ‘how-to augmented video’ for each of the different stakeholders (code reviewers, testers, and customers), as well as updating a “how to test guideline” is needed. Creating and updating these specialized videos for each stakeholder is a tedious and time-consuming challenge.

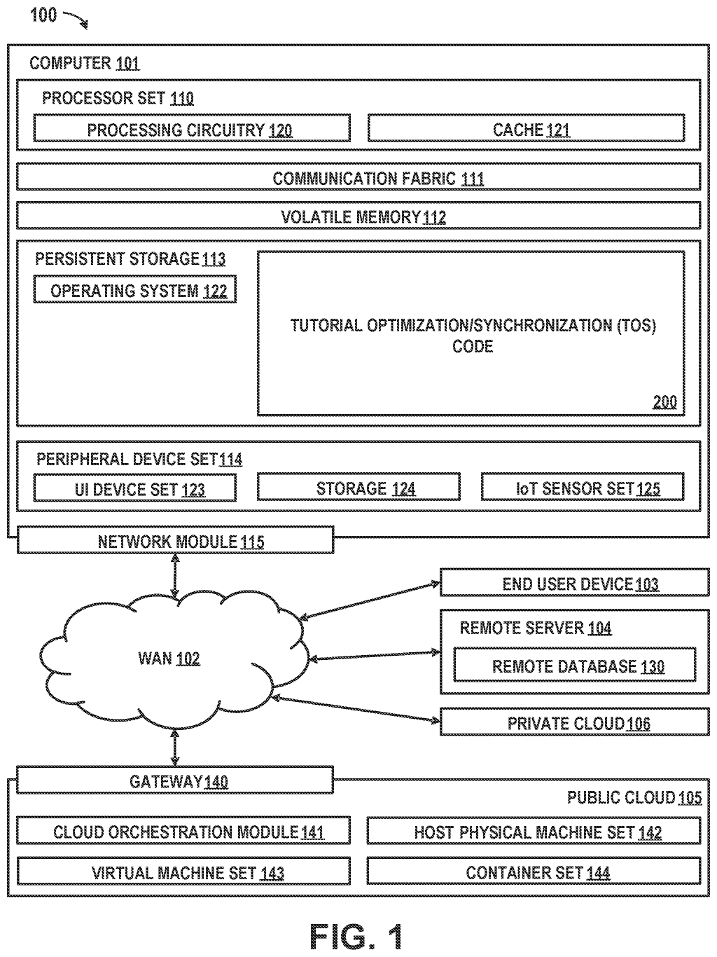

FIG. 1 is a functional block diagram illustration of a computing environment 100 that can communicate with various networked components, such as the cloud, a policy data source, etc. In particular, FIG. 1 illustrates a computing environment 100, as may be used to implement a component, such as, for example, a tutorial optimization and synchronization (TOS) manager module 320, a graphical user interface 361, a TOS identifier 330, a TOS verifier 340, and a TOS monitor 352.

Computing environment 100 includes an example of an environment for the execution of at least some of the computer code involved in performing the inventive methods, such as tutorial optimization/synchronization code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The present disclosure generally relates to methods for optimizing and synchronizing a tutorial. By virtue of the concepts discussed herein, detection and identification of changed/updated information in development activities of a tutorial are utilized to generate updated tutorial sections for inclusion in an updated tutorial document.

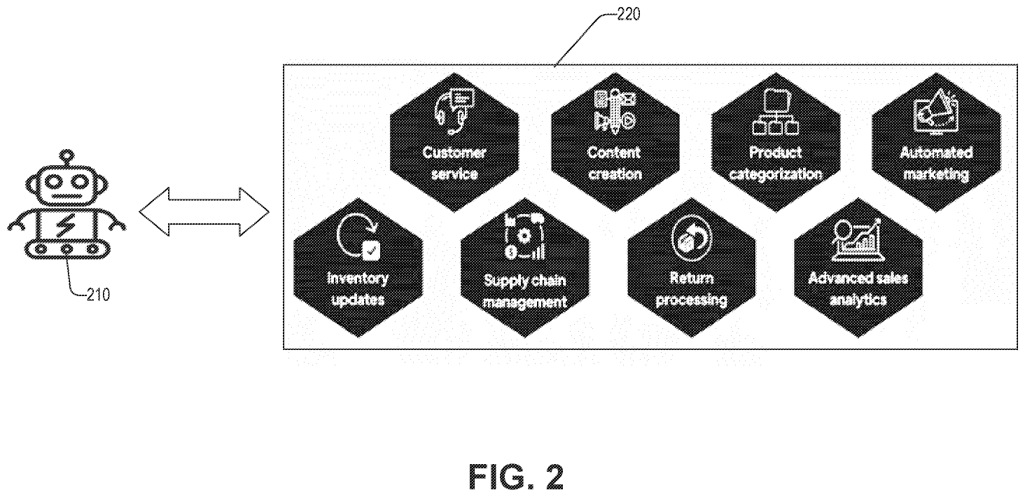

Reference is now made to FIG. 2, which is a conceptual block diagram showing a conventional bot and its associated functions. A conventional bot is a software program encoded to perform one or more automated, repetitive, or pre-defined tasks/functions to reduce the burden or time for an individual to perform a task/function. Examples of functions are found in block 220, which includes customer service, content creation, product categorization, automated marketing, inventory updates, supply chain management, return processing, and advanced sales analytics.

### Example Architecture

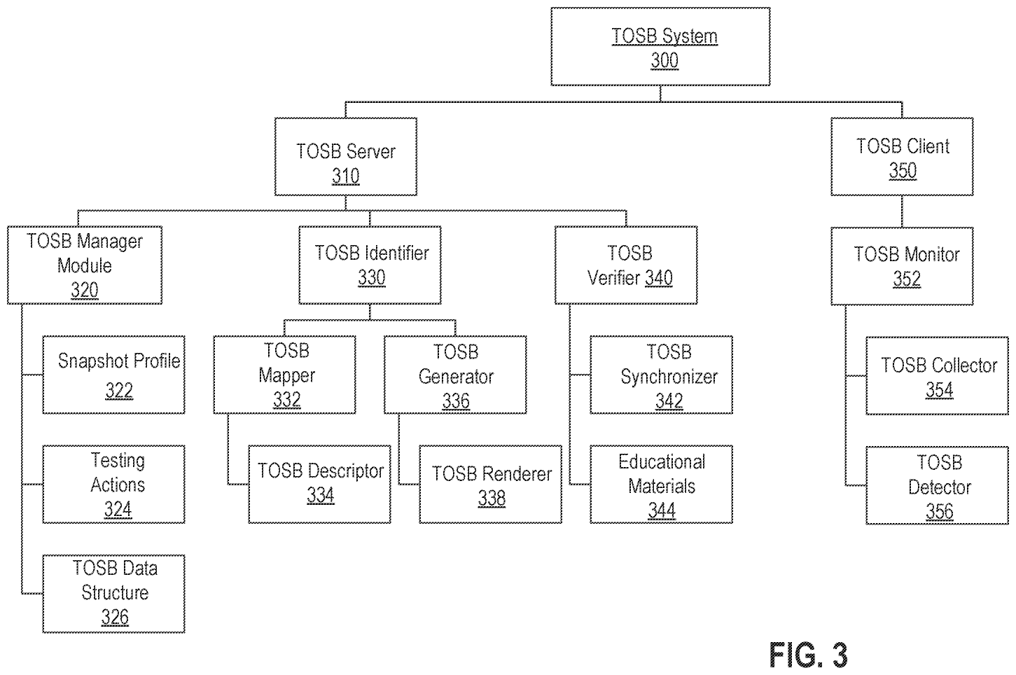

Reference is now made to FIG. 3, which presents a computing system 300 for optimizing and synchronizing a tutorial, consistent with an illustrative embodiment. For purposes of this disclosure, computing system 300 can be alternately referred to as a Tutorial Optimization and Synchronization System 300 or, in an alternative embodiment, a Tutorial Optimization and Synchronization Bot System 300 (with and without reference to a “bot”). Additionally, one or more components of computing system 300 can include a reference (or no reference) to “Tutorial Optimization and Synchronization” (TOS), or in embodiments referencing a bot, “Tutorial Optimization and Synchronization Bot” (TOSB). It is noted that TOSB server 310 and TOSB client 350 include, together or separately, one or more of: a memory, a network module, a processor, a GUI, and a non-transitory computer-readable storage medium.

The network module provides coupling between various components of computing system 300 so that tutorial data of a tutorial is shared between the components that are configured to optimize and synchronize portions of an updated tutorial and include TOSB server 310 (housing TOSB manager module 320, TOSB identifier 330, and TOSB verifier 340) and TOSB client 350 (housing TOSB monitor 352). The network module is coupled to the processor to enable the processor communication over a network established by the network module. Additionally, the non-transitory computer-readable storage device and the graphical user interface (GUI) are coupled to the processor.

The GUI is coupled to the processor to enable communication between computing system 300 and a user of computing system 300.

TOSB manager module 320, via TOSB server 310, is coupled to network module to enable storage and distribution of tutorial data to the other components of computing system 300. TOSB manager module 320 includes a snapshot profile 322, testing actions 324, and a TOSB data structure 326.

TOSB identifier 330, via TOSB server 310, is coupled to the processor to enable analysis of versions of a tutorial and identification of differences between versions of a tutorial. TOSB identifier 330 includes TOSB mapper 332, TOSB descriptor 334, TOSB generator 336, and TOSB renderer 338.

TOSB verifier 340, via TOSB server 310, is coupled to the processor to enable analysis of updated tutorial sections of a tutorial document. TOSB verifier 340 includes TOSB synchronizer 342 and educational materials 344 (alternatively referred to as educational material files 344).

TOSB monitor 352, via TOSB client 350, is coupled to the processor to enable the monitoring of development activities in development environments and tools relative to a tutorial. TOSB monitor 352 includes TOSB collector 354 and TOSB detector 356.

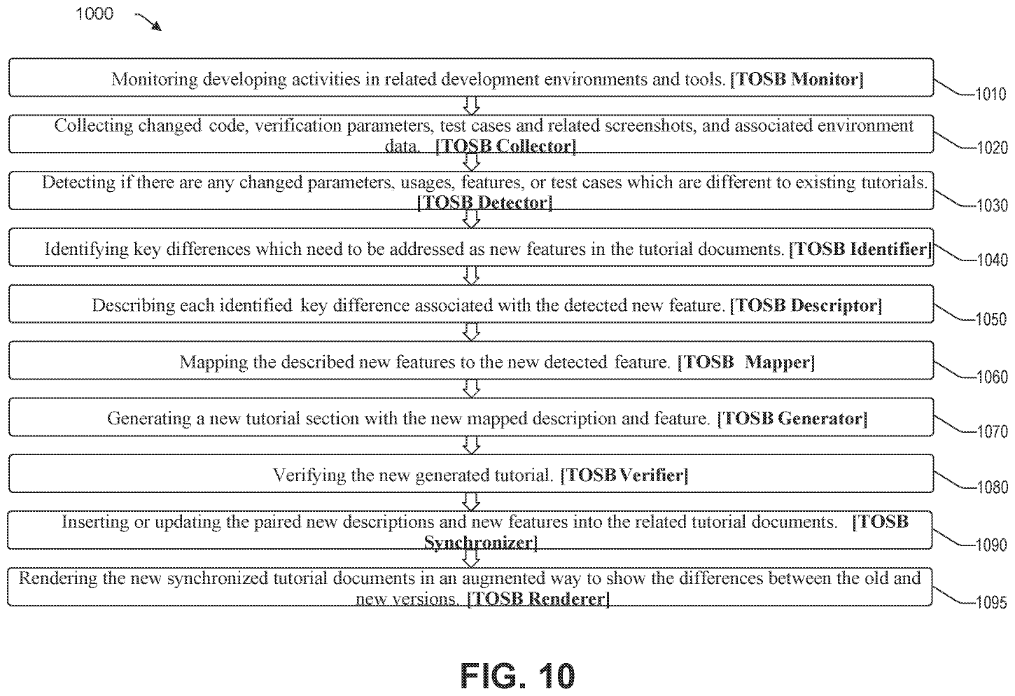

Program instructions (additionally referred to as tutorial optimization/synchronization code 200) stored on the non-transitory computer-readable storage device are configured for execution by the processor via a memory (similar to the volatile memory 112 of FIG. 1) coupled to the processor. The instructions are configured to render computing system 300 capable of performing a number of operations in a method for optimizing and synchronizing a tutorial (presented similarly in FIG. 10). The method includes monitoring, by the TOSB monitor 352, developing activities in development environments and tools relative to the tutorial. The TOSB collector 354 then collects information relative to the developing activities. The TOSB detector 356 then detects changed information within the information relative to the developing activities. In an embodiment, the changed information includes at least one of: parameters, usages, features, or test cases. Once the TOSB detector 356 detects changed information, the TOSB identifier 330 identifies one or more specific differences between the information and the changed information, where each of the one or more specific differences are configured to be addressed as an updated feature in a tutorial document. The TOSB descriptor 334 then describes each of the one or more specific differences.

Once the TOSB descriptor 334 describes each of the one or more specific differences, the TOSB mapper 332 then maps descriptions of each of the one or more specific differences to each of the updated features. The TOSB generator 336 then generates one or more updated tutorial sections each including a respective one of the descriptions of the one or more specific differences and a respective one of the one or more updated features. The TOSB verifier 340 then verifies the one or more updated tutorial sections. The TOSB synchronizer 342 then updates the tutorial document with each of the mapped descriptions of the one or more specific differences and each of the one or more updated features. Once the TOSB synchronizer 342 updates the tutorial document, the TOSB renderer 338 then renders an updated tutorial document to present differentiated aspects of portions of the tutorial and the updated tutorial.

In one embodiment, computing system 300 includes multiple computer systems (for example, one server and multiple clients). In a further embodiment, computing system 300 includes a single computer system (for example, a server program and a client program).

In one embodiment, features are identified using natural language processing (NLP). NLP is a field of artificial intelligence, computer science, and computational linguistics that deals with the interaction between a human (i.e., the natural element) and computers. In a further embodiment, the program instructions can be configured as code executable by a bot.

In one embodiment, the developing activities comprise testing activities. The information relative to the developing activities can include at least one of: changed code, code checkin/checkout, screenshots, verification code/script, verification parameters, realtime verification, log files in test systems, demos, associated environment settings, associated environment data, defect reports, design specifications, created/modified test cases, test scripts, test documents, test results, command output, or command related errors.

In one embodiment, execution of the instructions by the processor configures computing system 300 to additionally perform screenshotting, via the TOSB monitor 352, the developing activities for incorporation into the updated tutorial document. The computing system 300, in conjunction with the program instructions, may define a frame for supporting tutorial optimization and synchronization (TOS/TOSB). The frame can include at least one of: a TOSB server 310 (including a TOSB manager module 320, a snapshot profile 322, and testing actions 324) or a TOSB client 350.

In one embodiment, computing system 300, in conjunction with the program instructions, is further configured to define a data structure (such as, for example, TOSB data structure 326) for saving/holding TOS/TOSB data. The TOS/TOSB data may comprise a set of variables that includes, but is not limited to: ProductID, ComponentID, SourcefileID, FeatureID, TutorialID, TutorialURL, SourceCode [SourcefileID] [LineIndex], TutorialDescription [TutorialID] [FeatureID], or UpdateNotificationList (emails of document owner and/or reviewer, etc.).

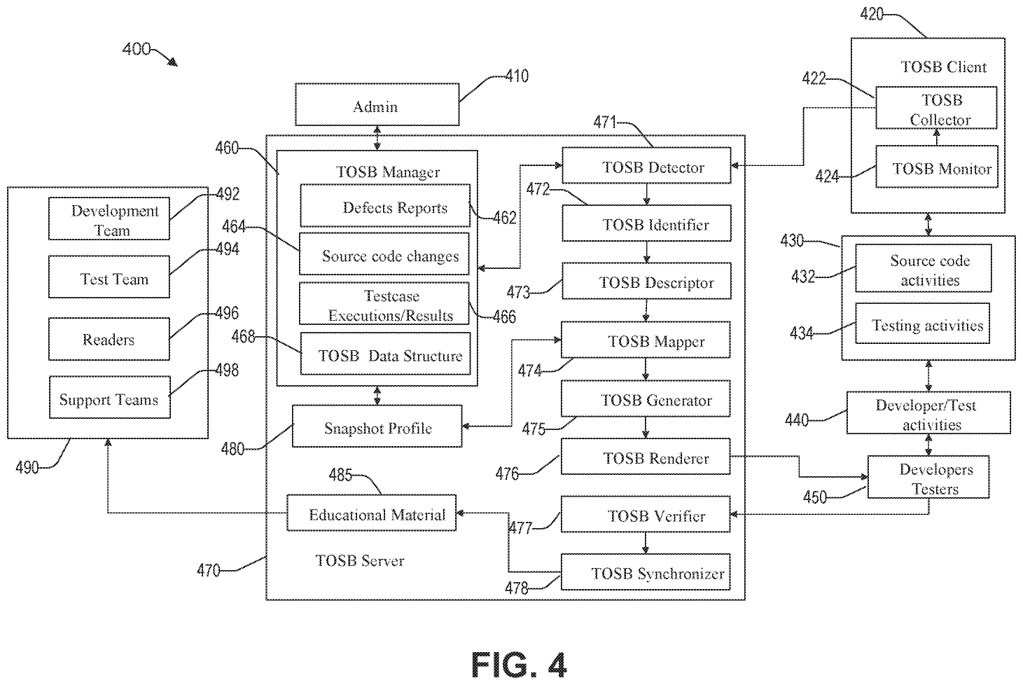

According to an embodiment, a computer program product for optimizing and synchronizing a tutorial is provided. The computer program product includes a computer readable storage medium embodying program instructions executable by a processor to cause the processor to perform a plurality of steps. These steps may correlate to any process steps/functions relative to any of FIGS. 4-10.

Reference is now made to FIG. 4, which is a flowchart 400 showing an exemplary process of optimizing and synchronizing a tutorial performed in the computing system 300 shown in FIG. 3, consistent with an illustrative embodiment. For discussion purposes, the flowchart 400 is described with reference to the architecture of environment 100 and computing system 300 of FIGS. 1 and 3. It is noted that the flow embodied in flowchart 400 embodies an exemplary method for optimizing and synchronizing a tutorial.

As shown, at block 460, TOSB manager module 320 includes data relative to tutorial optimization/synchronization code 200 and includes defect reports 462, source code changes 464, testcase executions/results 466, and TOSB data structure 468 (similar to TOSB data structure 326 of FIG. 3). Block 460, as shown, is coupled to snapshot profile 322 at block 480, which shares snapshots between TOSB descriptor 334 at block 473 and TOSB manager module 320 at block 460. Block 460 is further coupled to admin 410, which provides operational support to TOSB manager module 320 at block 460. Block 490 includes devices relevant to a development team 492, a test team 494, readers 496, and support teams 498. Block 490, as shown, is coupled to educational material/file 344 at block 485. At least one of a development team 492, a test team 494, readers 496, or support teams 498 receives updated tutorial documents from educational material/file 344 at block 485. Block 430 includes activities relative to tutorial optimization/synchronization code 200 and includes source code activities 432 and testing activities 434. Block 430, as shown, is coupled to TOSB client 350 at block 420 and developer/test activities at block 440; source code activities 432 and testing activities 434 are shared between block 420 and block 440. Block 450 includes developers and testers. Block 450, as shown, is coupled to block 440, where developers and testers share developer/test activities at block 440 to block 430. Block 450 is further coupled to TOSB verifier 340 at block 477, where developers and testers share developer/test activities at block 440 to TOSB verifier 340 at block 477.

Within block 470 that houses TOSB server 310, a plurality of blocks 471, 472, 473, 474, 475, 476, 477, and 478 include process steps relating to a method for optimizing and synchronizing a tutorial. It is noted that one or more of blocks 471, 472, 473, 474, 475, 476, 477, and 478 are connected to blocks and/or elements of computing system 300 located outside of block 470, implying that process steps or elements of computing system 300 are performed/utilized in conjunction with process steps or elements of computing system 300 not relative to block 470. For example, TOSB client 350 at block 420 includes process steps and/or elements that are performed/utilized in conjunction with process steps and/or elements of computing system 300 relative to block 470.

At block 424, a TOSB monitor 352 monitors developing activities in development environments and tools relative to the tutorial. At block 422, a TOSB collector 354 collects information relative to the developing activities. In an embodiment, the information relative to the developing activities includes at least one of: changed code, verification parameters, test cases, test case screenshots, or associated environment data. At block 471, detector 356 detects changed information within the information relative to the developing activities. To carry out this process, TOSB manager module 330 provides a framework for supporting tutorial optimization and synchronization (TOS) to TOSB detector 356 at block 471. At block 472, TOSB identifier 330 identifies one or more specific differences between the information and the changed information, where each of the one or more specific differences are configured to be addressed as an updated feature in a tutorial document. At block 473, a TOSB descriptor 334 describes each of the one or more specific differences.

At block 474, a TOSB mapper 332 maps descriptions of each of the one or more specific differences to each of the updated features and adds snapshots to each of the one or more specific differences. Snapshots are provided to TOSB mapper 332 from snapshot profile 322 at block 480. At block 475, TOSB generator 336 generates one or more updated tutorial sections, where each of the one or more updated tutorial sections includes a respective one of the descriptions of the one or more specific differences and a respective one of the one or more updated features. At block 476, TOSB renderer 338 renders an updated tutorial document to present differentiated aspects of portions of the tutorial and the updated tutorial. TOSB renderer 338 sends the updated tutorial document to TOSB verifier 340 via developers and testers at block 450. At block 477, TOSB verifier 340 verifies the updated tutorial document including the one or more updated tutorial sections. At block 478, TOSB synchronizer 342 updates the tutorial document with updated mapped descriptions and updated features (subsequent iterations of the tutorial document). Subsequently, updated tutorial documents are sent from TOSB synchronizer 478 as educational materials 344 to block 490 for access by at least one of a development team 492, a test team 494, readers 496, or support teams 498.

In one embodiment, computing system 300, in conjunction with the program instructions, is further configured to define a frame for supporting tutorial optimization and synchronization (TOS/TOSB). The frame can include at least one of: a TOSB server 310 (including a TOSB manager module 320, a snapshot profile 322, and testing actions 324) or a TOSB client 350.

In one embodiment, computing system 300, in conjunction with the program instructions, is further configured to define a data structure (such as, for example, TOSB data structure 326) for saving/holding TOS/TOSB data. The TOS/TOSB data may comprise a set of variables including at least one of: ProductID, ComponentID, SourcefileID, FeatureID, TutorialID, TutorialURL, SourceCode [SourcefileID] [LineIndex], TutorialDescription [TutorialID] [FeatureID] or UpdateNotificationList (emails of document owner and/or reviewer, etc.).

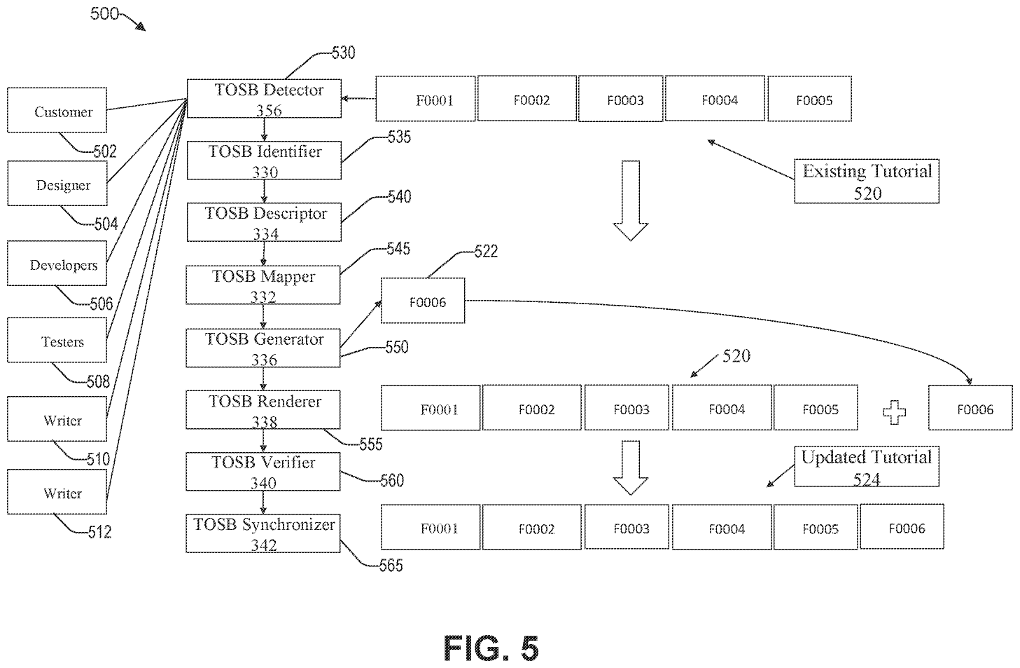

Reference is now made to FIG. 5, which is a flowchart 500 showing an additional exemplary process of optimizing and synchronizing a tutorial 520 (alternatively referred to as existing tutorial 520) performed in the computing system 300 shown in FIG. 3, consistent with an illustrative embodiment. As shown, at block 530, TOSB detector 356 detects changed information within information relative to developing activities associated with existing tutorial 520, where the developing activities are performed by any of customer 502, designer 504, developers 506, testers 508, and writers 510, 512. At block 535, TOS identifier 330 identifies one or more specific differences between the information and the changed information, where each of the one or more specific differences are configured to be addressed as an updated feature in a tutorial document. At block 540, TOSB descriptor 334 describes each of the one or more specific differences. At block 545, TOSB mapper 332 maps descriptions of each of the one or more specific differences to each of the updated features.

At block 550, TOSB generator 336 generates an updated tutorial section 522 that is added to existing tutorial 520, where the updated tutorial section 522 includes a respective one of the descriptions of the one or more specific differences and a respective one of the one or more updated features. At block 555, TOSB renderer 338 renders an updated tutorial document to present differentiated aspects of portions of the tutorial 520 and the updated tutorial 524. At block 560, TOSB verifier 340 verifies the updated tutorial document including the updated tutorial section 522. At block 565, TOSB synchronizer 342 updates the tutorial document with updated mapped descriptions and updated features (subsequent iterations of the tutorial document).

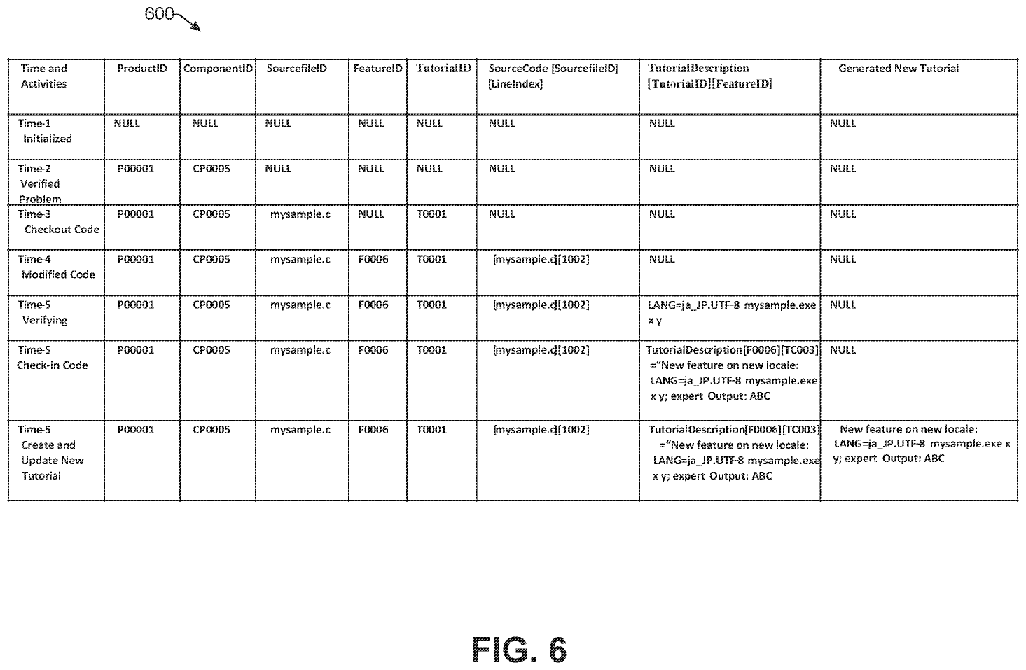

Reference is now made to FIG. 6, which is a chart 600 showing an exemplary data update of an optimization and synchronization of a tutorial, consistent with an illustrative embodiment. As shown, the columns of chart 600 present variables that define a data structure for holding/saving TOSB/TOS data (TOSB data structure 326) and include: ProductID, ComponentID, SourcefileID, FeatureID (for example, updated tutorial section 522), TutorialID (for example, tutorial 520), SourceCode ([SourcefileID], [LineIndex]), TutorialDescription ([TutorialID], [FeatureID]), and Generated New Tutorial. At Time-1 (Initialized Stage), no identifying information is produced. At Time-2 (Verified Problem Stage utilizing TOSB Detector 356), a Product ID (P00001) and a Component ID (CP0005) are produced. At Time-3 (Checkout Code Stage), a SourcefileID (mysample.c) and a TutorialID (T0001) are produced. At Time-4 (Modified Code Stage utilizing TOSB Generator 336), a FeatureID (F0006) and a SourceCode ([mysample.c] [1002]) are produced. At Time-5 (Verifying Stage utilizing TOSB Verifier 340), a TutorialDescription (LANG=ja_JP.UTF8 mysample.exe x y) is produced. At Time-5 (Check-in Stage), a TutorialDescription is updated to “TutorialDescription [F0006] [TC003]=“New feature on new locale: LANG-ja_JP.UTF-8 mysample.exe x y; expert Output: ABC.” At Time-5 (Create and Update New Tutorial Stage utilizing TOSB synchronizer 342 and TOSB renderer 338), a Generated New Tutorial (“New feature on new locale: LANG=ja_JP.UTF-8 mysample.exe x y; expert Output: ABC”) is produced.

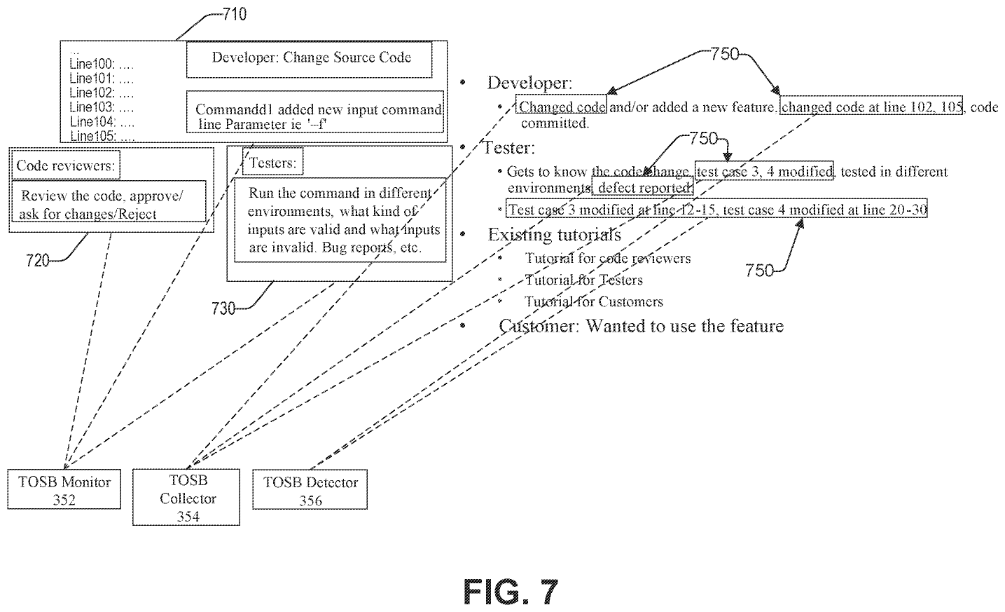

Reference is now made to FIG. 7, which is a diagram of exemplary developing activities 710,720,730 within an integrated development environment (IDE), consistent with an illustrative embodiment. As shown, TOSB monitor 352 monitors developing activities 710,720,730 of a tutorial; in this embodiment, the developing activities 710,720,730 are relative to developers, code reviewers, and testers. TOSB collector 354 then collects information 750 relative to the developing activities 710,720,730; the exemplary information 750 includes: “changed code”, “test case 3, 4 modified”, and “defect reported”. In an embodiment, the information 750 relative to the developing activities comprises at least one of: changed code, verification parameters, test cases, test case screenshots, or associated environment data. TOSB detector 356 then detects changed information within the information 750 relative to developing activities 710,720,730; the changed information includes: “changed code at line 102, 105” and “Test case 3 modified at line 12-15, test case 4 modified at line 20-30”.

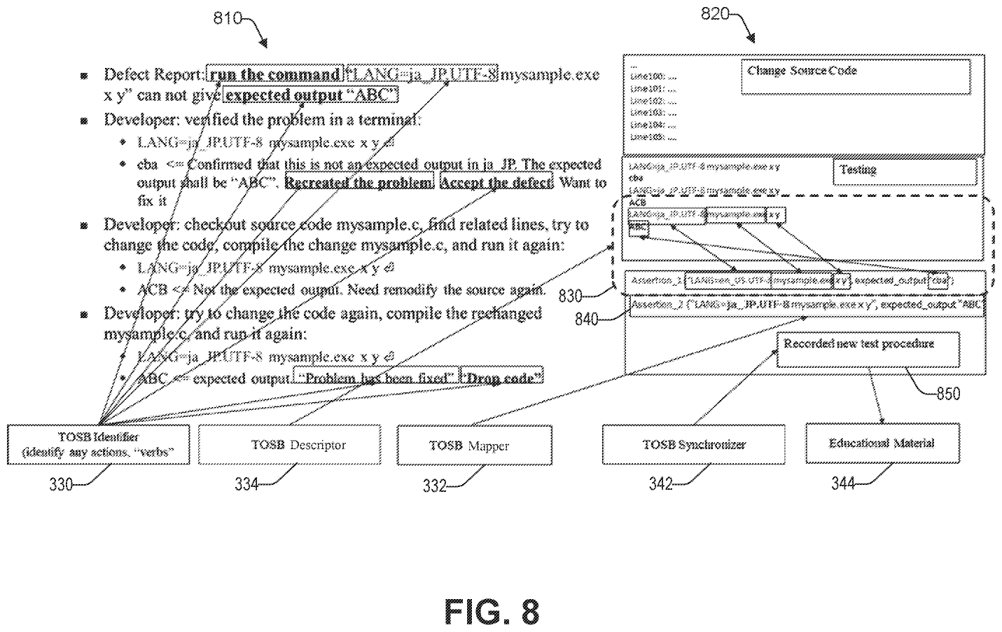

Reference is now made to FIG. 8, which is a diagram of additional exemplary developing activities 820 within an integrated development environment (IDE), consistent with an illustrative embodiment. As shown, TOSB identifier 330 identifies one or more specific differences between the information 810 and the changed information, where each of the one or more specific differences are configured to be addressed as an updated feature 840 in a tutorial document 850. The specific differences identified by TOSB identifier 330 includes: “run the command”, ‘expected output “ABC”’, “Recreated the problem”, “LANG=ja_JP.UTF-8”, “Accept the defect”, “Problem has been fixed”, and “Drop code”. In an embodiment, TOSB identifier 330 is configured to identify any actions (or specifically, “verbs”) that can denote a difference between the information 810 and changed information. TOSB descriptor 334 then describes each of the one or more specific differences; in this case, TOSB descriptor 334 describes differences in relation to updated feature 840. TOSB mapper 332 then maps descriptions of each of the one or more specific differences to each of the updated features, which is shown at block 830. TOSB synchronizer 342 then updates tutorial document 850 (Recorded new test procedure) with each of the mapped descriptions of the one or more specific differences and each of the one or more updated features. Tutorial document 850 is subsequently stored as educational material 344, where tutorial document 850 can be accessed by at least one of a development team 492, a test team 494, readers 496, or support teams 498.

In a further embodiment, the developing activities 710,720,730,820 comprise testing activities. In an additional embodiment, the information relative to the developing activities 710,720,730,820 comprises at least one of: changed code, code checkin/checkout, screenshots, verification code/script, verification parameters, realtime verification, log files in test systems, demos, associated environment settings, associated environment data, defect reports, design specifications, created/modified test cases, test scripts, test documents, test results, command output, or command related errors.

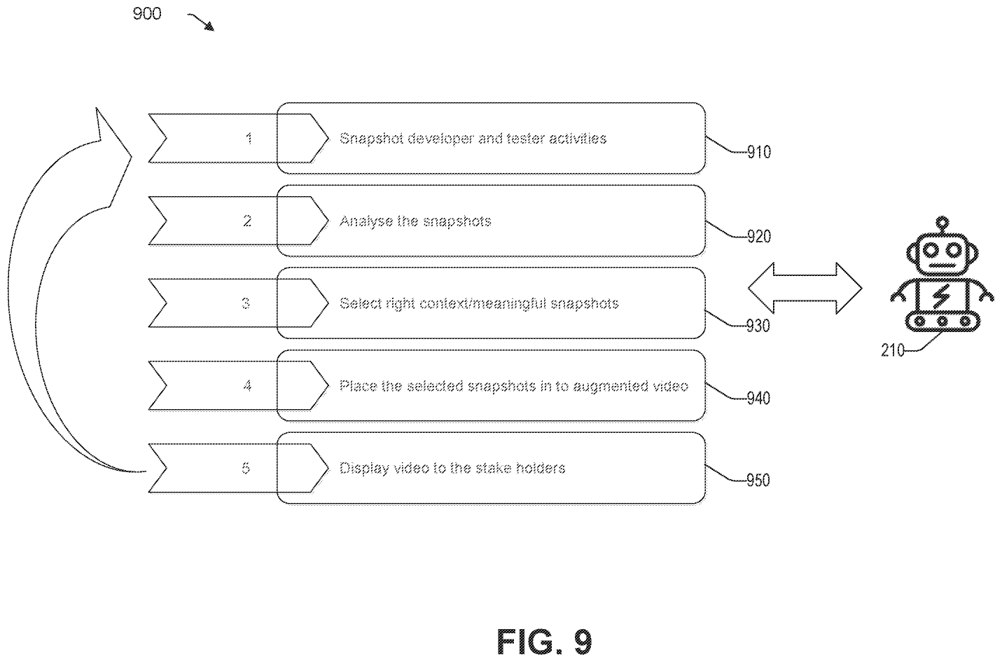

With the foregoing overview of the example architecture/environment/computing system 100,300, it may be helpful to consider a high-level discussion of an example process. To that end FIG. 9 presents a flowchart 900 for an example integration workflow of a tutorial optimization and synchronization bot (TOSB) 210, consistent with an illustrative embodiment.

Flowchart 900 is illustrated as a process in logical flowchart format, wherein the flowchart represents a sequence of operations that can be implemented in hardware, software, or a combination thereof. In the context of software, the process represents computer-executable instructions that, when executed by one or more processors, perform the recited operations. Generally, computer-executable instructions may include routines, programs, objects, components, data structures, and the like that perform functions or implement abstract data types. The order in which the operations are described is not intended to be construed as a limitation, and any number of the described processes can be combined in any order and/or performed in parallel to implement the process. For discussion purposes, the integration workflow of tutorial optimization and synchronization bot 210 is described with reference to the architecture of environment 100 and system 300 of FIGS. 1 and 3.

At block 910, a TOSB monitor 352 takes one or more snapshot of developer and tester activities, where the snapshots are stored in TOSB manager module 320.

At block 920, a TOSB descriptor 334 analyzes the snapshots.

At block 930, a TOSB identifier 330 selects proper contextual/relevant/meaningful snapshots for inclusion in an updated tutorial.

At block 940, a TOSB synchronizer 342 places the selected snapshots into an augmented video (tutorial).

At block 950, a TOSB server 310 displays an updated tutorial to stakeholders via GUI 316.

Reference is now made to FIG. 10, which presents a flowchart 1000 for a method for optimizing and synchronizing a tutorial, consistent with an illustrative embodiment. Flowchart 1000 of method is illustrated as a process in logical flowchart format, wherein the flowchart represents a sequence of operations that can be implemented in hardware, software, or a combination thereof. In the context of software, the process represents computer-executable instructions that, when executed by one or more processors, perform the recited operations. Generally, computer-executable instructions may include routines, programs, objects, components, data structures, and the like that perform functions or implement abstract data types. The order in which the operations are described is not intended to be construed as a limitation, and any number of the described processes can be combined in any order and/or performed in parallel to implement the process. For discussion purposes, the method 1000 is described with reference to the architecture of environment 100 and system 300 of FIGS. 1 and 3.

At block 1010, a TOS monitor 352 monitors developing activities in development environments and tools relative to the tutorial.

At block 1020, a collector 354 collects information relative to the developing activities. In an embodiment, the information can include, but is not limited to: changed code, verification parameters, test cases and related screenshots, or associated environment data.

At block 1030, a detector 356 detects if there is any changed information that is different than the information relative to any existing tutorials. In an embodiment, the changed information can include, but is not limited to: changed parameters, changed usages, changed features, or changed test cases.

At block 1040, a TOS identifier 330 identifies key differences between the information and the changed information that are configured to be addressed as new features in the tutorial document(s).

At block 1050, a descriptor 334 describes each of the identified key differences associated with each of the detected new features.

At block 1060, a mapper 332 maps the described new features to the new detected features.

At block 1070, a generator 336 generates a new tutorial section with the new mapped descriptions and features.

At block 1080, a TOS verifier 340 verifies the new generated tutorial.

At block 1090, a synchronizer 342 inserts/updates the paired new descriptions and new features into the related tutorial documents.

At block 1095, a renderer 338 renders the new tutorial document(s) in an augmented way to show the differences between the old and new versions of the tutorial document(s).

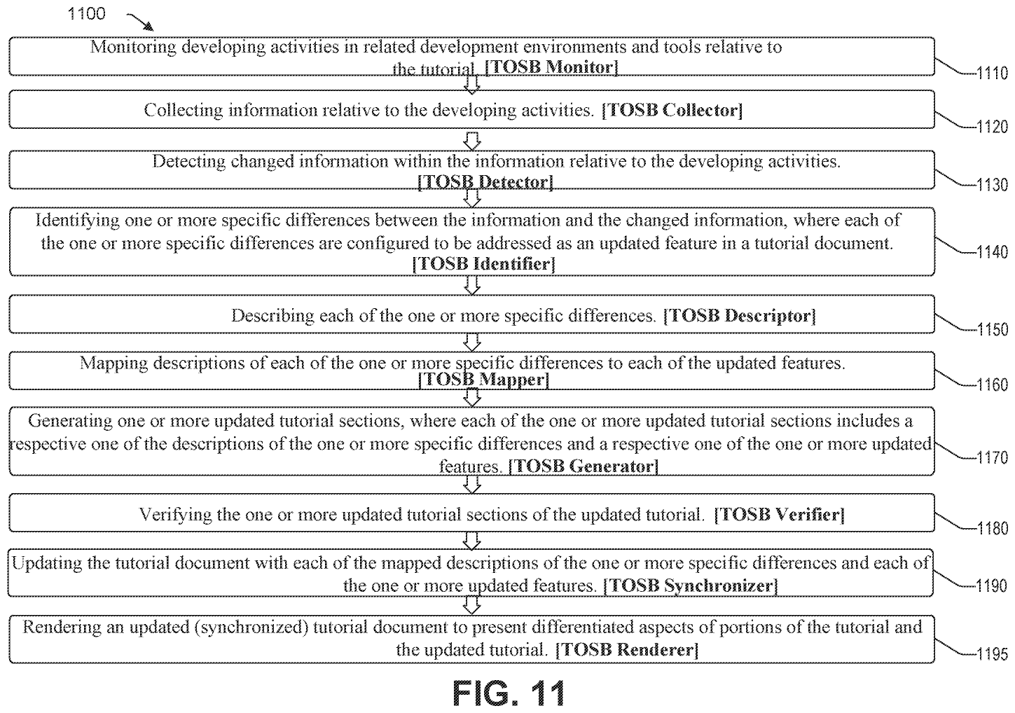

Reference is now made to FIG. 11, which presents a flowchart 1100 for a method for optimizing and synchronizing a tutorial, consistent with an illustrative embodiment. Flowchart 1100 of method is illustrated as a process in logical flowchart format, wherein the flowchart represents a sequence of operations that can be implemented in hardware, software, or a combination thereof. In the context of software, the process represents computer-executable instructions that, when executed by one or more processors, perform the recited operations.

Generally, computer-executable instructions may include routines, programs, objects, components, data structures, and the like that perform functions or implement abstract data types. The order in which the operations are described is not intended to be construed as a limitation, and any number of the described processes can be combined in any order and/or performed in parallel to implement the process. For discussion purposes, the method 1100 is described with reference to the architecture of environment 100 and system 300 of FIGS. 1 and 3.

At block 1110, a TOS monitor 352 monitors developing activities in development environments and tools relative to the tutorial.

At block 1120, a collector 354 collects information relative to the developing activities.

At block 1130, a detector 356 detects changed information within the information relative to the developing activities.

At block 1140, a TOS identifier 330 identifies one or more specific differences between the information and the changed information, where each of the one or more specific differences are configured to be addressed as an updated feature in a tutorial document.

At block 1150, a descriptor 334 describes each of the one or more specific differences.

At block 1160, a mapper 332 maps descriptions of each of the one or more specific differences to each of the updated features.

At block 1170, a generator 336 generates one or more updated tutorial sections, where each of the one or more updated tutorial sections includes a respective one of the descriptions of the one or more specific differences and a respective one of the one or more updated features.

At block 1180, a TOS verifier 340 verifies the one or more updated tutorial sections of the updated tutorial.

At block 1190, a synchronizer 342 updates the tutorial document with each of the mapped descriptions of the one or more specific differences and each of the one or more updated features.

At block 1195, a renderer 338 renders an updated (synchronized) tutorial document to present differentiated aspects of portions of the tutorial and the updated tutorial.

In an embodiment, the program instructions can be configured as code executable by a bot.

In one embodiment, the developing activities comprise testing activities. The information relative to the developing activities can include at least one of: changed code, code checkin/checkout, screenshots, verification code/script, verification parameters, realtime verification, log files in test systems, demos, associated environment settings, associated environment data, defect reports, design specifications, created/modified test cases, test scripts, test documents, test results, command output, or command related errors.

In a further embodiment, the integration workflow of flowchart 900/tutorial optimization and synchronization method of flowchart 1000/tutorial optimization and synchronization method of flowchart 1100 further includes screenshotting, via the TOSB monitor 352, the developing activities for incorporation into the updated tutorial document.

In a further embodiment, the integration workflow of flowchart 900/the tutorial optimization and synchronization method of flowchart 1000/tutorial optimization and synchronization method of flowchart 1100 further includes defining a frame for supporting tutorial optimization and synchronization (TOS/TOSB). In an additional embodiment, the frame can include at least one of: a TOSB server 310 (including a TOSB manager module 320, a snapshot profile 322, and testing actions 324) or a TOSB client 350.

In a further embodiment, the integration workflow of flowchart 900/the tutorial optimization and synchronization method of flowchart 1000/tutorial optimization and synchronization method of flowchart 1100 further includes defining a data structure (such as, for example, TOSB data structure 326) for saving/holding TOS/TOSB data. In an additional embodiment, TOS/TOSB data comprises a set of variables including, but is not limited to: ProductID, ComponentID, SourcefileID, FeatureID, TutorialID, TutorialURL, SourceCode [SourcefileID] [LineIndex], TutorialDescription [TutorialID] [FeatureID], or UpdateNotificationList (emails of document owner and/or reviewer, etc.).

Importantly, although the operational/functional descriptions described herein may be understandable by the human mind, they are not abstract ideas of the operations/functions divorced from computational implementation of those operations/functions. Rather, the operations/functions represent a specification for an appropriately configured computing device. As discussed in detail below, the operational/functional language is to be read in its proper technological context, i.e., as concrete specifications for physical implementations.

Accordingly, one or more of the methodologies discussed herein may obviate a need for time consuming data processing by the user. This may have the technical effect of reducing computing resources used by one or more devices within the system. Examples of such computing resources include, without limitation, processor cycles, network traffic, memory usage, storage space, and power consumption.

It should be appreciated that aspects of the teachings herein are beyond the capability of a human mind. It should also be appreciated that the various embodiments of the subject disclosure described herein can include information that is impossible to obtain manually by an entity, such as a human user. For example, the type, amount, and/or variety of information included in performing the process discussed herein can be more complex than information that could be reasonably be processed manually by a human user.

### CONCLUSION

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to call flow illustrations and/or block diagrams of a method, apparatus (systems), and computer program products according to embodiments of the present disclosure. It will be understood that each step of the flowchart illustrations and/or block diagrams, and combinations of blocks in the call flow illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the call flow process and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the call flow and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the call flow process and/or block diagram block or blocks.

The flowchart and block diagrams in the Figures illustrate the architecture, functionality, and operation of possible implementations of systems, methods, and computer program products according to various embodiments of the present disclosure. In this regard, each block in the call flow process or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or call flow illustration, and combinations of blocks in the block diagrams and/or call flow illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A method for optimizing and synchronizing a tutorial using a TOS (Tutorial Optimization and Synchronization) identifier including a descriptor, a mapper, a generator, and a renderer; a TOS verifier including a synchronizer; and a TOS monitor including a collector and a detector; the method comprising:
monitoring, by the TOS monitor, developing activities in development environments and tools relative to the tutorial;
collecting, via the collector, information relative to the developing activities;
detecting, by the detector, changed information within the information relative to the developing activities;
identifying, by the TOS identifier, one or more specific differences between the information and the changed information, wherein each of the one or more specific differences are configured to be addressed as an updated feature in a tutorial document;
describing, by the descriptor, each of the one or more specific differences;
mapping, via the mapper, descriptions of each of the one or more specific differences to each of the updated features;
generating, via the generator, one or more updated tutorial sections, wherein each of the one or more updated tutorial sections includes a respective one of the descriptions of the one or more specific differences and a respective one of the one or more updated features;
verifying, via the TOS verifier, the one or more updated tutorial sections;
updating, via the synchronizer, the tutorial document with each of the mapped descriptions of the one or more specific differences and each of the one or more updated features; and
rendering, via the renderer, an updated tutorial document to present differentiated aspects of portions of the tutorial and the updated tutorial.

2. The method of claim 1, wherein the method is configured as code executable by a bot.

3. The method of claim 1, wherein the developing activities comprise testing activities.

4. The method of claim 3, wherein the information relative to the developing activities comprises at least one of: changed code, code checkin/checkout, screenshots, verification code/script, verification parameters, realtime verification, log files in test systems, demos, associated environment settings, associated environment data, defect reports, design specifications, created/modified test cases, test scripts, test documents, test results, command output, or command related errors.

5. The method of claim 3, further comprising screenshotting, via the TOS monitor, the developing activities for incorporation into the updated tutorial document.

6. The method of claim 1, wherein the changed information comprises at least one of: parameters, usages, features, or test cases.

7. The method of claim 1, further comprising defining a data structure for saving TOS data.

8. A computer program product for optimizing and synchronizing a tutorial, the computer program product comprising a computer readable storage medium having program instructions embodied therewith, the program instructions executable by a processor to cause the processor to perform:
monitoring, by a TOS monitor, developing activities in development environments and tools relative to the tutorial;
collecting, via a collector, information relative to the developing activities;
detecting, by a detector, changed information within the information relative to the developing activities;
identifying, by a TOS identifier, one or more specific differences between the information and the changed information, wherein each of the one or more specific differences are configured to be addressed as an updated feature in a tutorial document;
describing, by a descriptor, each of the one or more specific differences;
mapping, via a mapper, descriptions of each of the one or more specific differences to each of the updated features;
generating, via a generator, one or more updated tutorial sections, wherein each of the one or more updated tutorial sections includes a respective one of the descriptions of the at least one specific differences and a respective one of the one or more updated features;
verifying, via a TOS verifier, the one or more updated tutorial sections;
updating, via a synchronizer, the tutorial document with each of the mapped descriptions of the one or more specific differences and each of the one or more updated features; and
rendering, via a renderer, an updated tutorial document to present differentiated aspects of portions of the tutorial and the updated tutorial.

9. The computer program product of claim 8, wherein the program instructions are executable by a bot.

10. The computer program product of claim 8, wherein the developing activities comprise testing activities.

11. The computer program product of claim 10, wherein the information relative to the developing activities comprises at least one of: changed code, code checkin/checkout, screenshots, verification code/script, verification parameters, realtime verification, log files in test systems, demos, associated environment settings, associated environment data, defect reports, design specifications, created/modified test cases, test scripts, test documents, test results, command output, or command related errors.

12. The computer program product of claim 10, further comprising screenshotting, via the TOS monitor, the developing activities for incorporation into the updated tutorial document.

13. The computer program product of claim 8, wherein the changed information comprises at least one of: parameters, usages, features, or test cases.

14. A computing system comprising:
a processor;
a network module coupled to the processor to enable communication over a network;
a computer-readable storage device coupled to the processor;
a tutorial optimization and synchronization (TOS) manager module coupled to the network module;
a graphical user interface coupled to the processor;
a TOS identifier coupled to the processor, the TOS identifier including a descriptor, a mapper, a generator, and a renderer;
a TOS verifier coupled to the processor, the TOS verifier including a synchronizer;
a TOS monitor coupled to the processor, the TOS monitor including a collector and a detector;
and
program instructions stored on the computer-readable storage device for execution by the processor via a memory, wherein execution of the instructions by the processor configures the computing device to perform a tutorial optimization and synchronization method comprising:
monitoring, by the TOS monitor, developing activities in development environments and tools relative to the tutorial;
collecting, via the collector, information relative to the developing activities;
detecting, by the detector, changed information within the information relative to the developing activities;
identifying, by the TOS identifier, one or more specific differences between the information and the changed information, wherein each of the one or more specific differences are configured to be addressed as an updated feature in a tutorial document;
describing, by the descriptor, each of the one or more specific differences;
mapping, via the mapper, descriptions of each of the one or more specific differences to each of the updated features;
generating, via the generator, one or more updated tutorial sections, wherein each of the one or more updated tutorial sections includes a respective one of the descriptions of the one or more specific differences and a respective one of the one or more updated features;
verifying, via the TOS verifier, the one or more updated tutorial sections;
updating, via the synchronizer, the tutorial document with each of the mapped descriptions of the one or more specific differences and each of the one or more updated features; and
rendering, via the renderer, an updated tutorial document to present differentiated aspects of portions of the tutorial and the updated tutorial.

15. The computing system of claim 14, wherein the program instructions are configured as code executable by a bot.

16. The computing system of claim 14, wherein the developing activities comprise testing activities.

17. The computing system of claim 16, wherein the information relative to the developing activities comprises at least one of: changed code, code checkin/checkout, screenshots, verification code/script, verification parameters, realtime verification, log files in test systems, demos, associated environment settings, associated environment data, defect reports, design specifications, created/modified test cases, test scripts, test documents, test results, command output, or command related errors.

18. The computing system of claim 16, further comprising screenshotting, via the TOS monitor, the developing activities for incorporation into the updated tutorial document.

19. The computing system of claim 14, wherein the changed information comprises at least one of: parameters, usages, features, or test cases.

20. The computing system of claim 14, further comprising defining a data structure for saving TOS data.
